(19) United States
(12) Patent Application Publication
(10) Pub. No.: US 2006/0240310 A1
(43) Pub. Date: Oct. 26, 2006

(54) Fuel cell system

(76) Inventor: Tomoaki Arimura, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/357,840

(22) Filed: Feb. 17, 2006

(30) Foreign Application Priority Data
Apr. 22, 2005 (JP) 2005-125407

(51) Int. Cl. H01M 8/04

(52) U.S. Cl. 429/38

(57) ABSTRACT

According to one embodiment, a fuel cell system includes a cell unit having a plurality of laminated single cells, a circulating pipeline connected to a fuel electrode of each single cell of the cell unit, a cartridge fuel tank attachably and detachably disposed on the circulating pipeline and filled with a fuel comprising an aqueous methanol solution, a cleaning liquid tank attachably and detachably disposed on the circulating pipeline and filled with a cleaning liquid containing a particular cyclic organic compound as a detergent, a fuel pump disposed on the circulating pipeline, and flow passageway switching means for discharging the cleaning liquid after cleaning the fuel electrode of the cell unit, the switching means being disposed on a downstream side of the cell unit.

### CROSS-REFERENCE TO RELATED APPLICATIONS

This application is based upon and claims the benefit of priority from Japanese Patent Application No. 2005-125407, filed Apr. 22, 2005, the entire contents of which are incorporated herein by reference.

### BACKGROUND

1. Field

One embodiment of the present invention relates to a fuel cell system.

2. Description of the Related Art

A direct methanol fuel cell (DMFC) has a structure comprising a membrane electrode unit, and a plurality of laminated unit cells including a fuel flow passageway plate and oxidative gas flow passageway plate disposed on both faces of each membrane electrode unit. The membrane electrode unit comprises a fuel electrode to which a mixed solution of methanol and water is supplied as a fuel, an air electrode to which oxidative gas is supplied, and a polymer electrolyte membrane interposed between these electrodes.

DMFCs are classified into a fuel circulating type for circulating the fuel, and a spontaneous respiration type for directly disposing the fuel after supplying the fuel to the fuel electrode. In the circulating DMFC, a fuel tank is connected to the fuel electrode through a circulation pipeline, the fuel including an aqueous methanol solution in the fuel tank is supplied to the fuel electrode through the circulation pipeline (an outbound pipeline) using a fuel pump, and an unreacted fuel is recycled to the fuel tank through a fuel recycling pipeline (a homebound pipeline).

However, impurities (for example, metal ions such as Al ion and organic substances) generated in the unit cell, pipelines and fuel pump are accumulated on the fuel electrode of the unit cell with time in the case of the circulating DMFC. Consequently, the activity of a catalyst layer in the fuel electrode of the unit cell is deteriorated to cause a decrease in the output power.

Based on the facts above, Jpn. Pat. Appln. KOKAI Publication No. 2004-227844 discloses a fuel cell for generating electricity by supplying fuel gas such as hydrogen generated in a refiner to a fuel electrode, wherein a collector accommodating a liquid chelating agent is provided in a pipeline for supplying the fuel gas to the fuel electrode to trap the impurities in the fuel gas.

Jpn. Pat. Appln. KOKAI Publication No. 2004-213978 describes a fuel cell for generating power by supplying fuel gas such as hydrogen generated in a refiner to a fuel electrode, wherein the fuel electrode is cleaned by supplying and recycling water or a dilute aqueous sulfuric acid to the fuel electrode from an interchangeable storage tank.

However, it is difficult to sufficiently remove the impurities, particularly metal ions, even by cleaning the fuel electrode of the DMFC of the recycling type by supplying the chelating agent described in Jpn. Pat. Appln. KOKAI Publication No. 2004-227844.

It is also difficult to remove the impurities such as metal ions even by employing cleaning of water in the DMFC of the recycling type as disclose in Jpn. Pat. Appln. KOKAI Publication No. 2004-213978. Catalysts of the fuel electrode may be dissolved when cleaning with the dilute aqueous sulfuric acid is applied to the fuel electrode of the DMFC of the recycling type.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not limit the scope of the invention.

FIG. 1 is an exemplary schematic view showing a direct methanol fuel cell according to a first embodiment of the invention;

FIG. 2 is an exemplary schematic exploded perspective view showing a single cell assembled in a unit cell of FIG. 1;

FIG. 3 is an exemplary sectional view showing a membrane electrode unit assembled in the single cell of FIG. 2;

FIG. 4 is an exemplary schematic view showing a direct methanol fuel cell according a second embodiment of the invention;

FIG. 5 is a graph showing the result of a quantitative analysis of the concentration of metal ions within a circulation system containing fuel electrodes in Examples 1 to 3 and Reference Example 1;

FIG. 6 is a graph showing the result of a quantitative analysis of the concentration of organic substances within the circulation system containing the fuel electrodes in Examples 1 to 3 and Comparative Example 1; and

FIG. 7 is a graph showing electric current-voltage characteristics of a fuel cell stack after cleaning in Examples 1 to 3 and Comparative Example 1.

### DETAILED DESCRIPTION

Various embodiments according to the invention will be described hereinafter with reference to the accompanying drawings.

In general, according to the invention, a fuel cell system comprises, a cell unit having a plurality of laminated single cells; a circulating pipeline connected to a fuel electrode of each single cell of the cell unit; a cartridge fuel tank attachably and detachably disposed on the circulating pipeline and filled with a fuel comprising an aqueous methanol solution; a cleaning liquid tank attachably and detachably disposed on the circulating pipeline and filled with a cleaning liquid containing a cyclic organic compound represented by a general formula (I) below as a detergent; a fuel pump disposed on the circulating pipeline; and flow passageway switching means for discharging the cleaning liquid after cleaning the fuel electrode of the cell unit, the switching means being disposed on a downstream side of the cell unit.

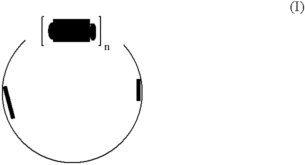

where R¹ denotes an alkyl chain with a carbon number of 1 to 12, R² denotes oxygen or sulfur, and n denotes an integer of 3 to 40.

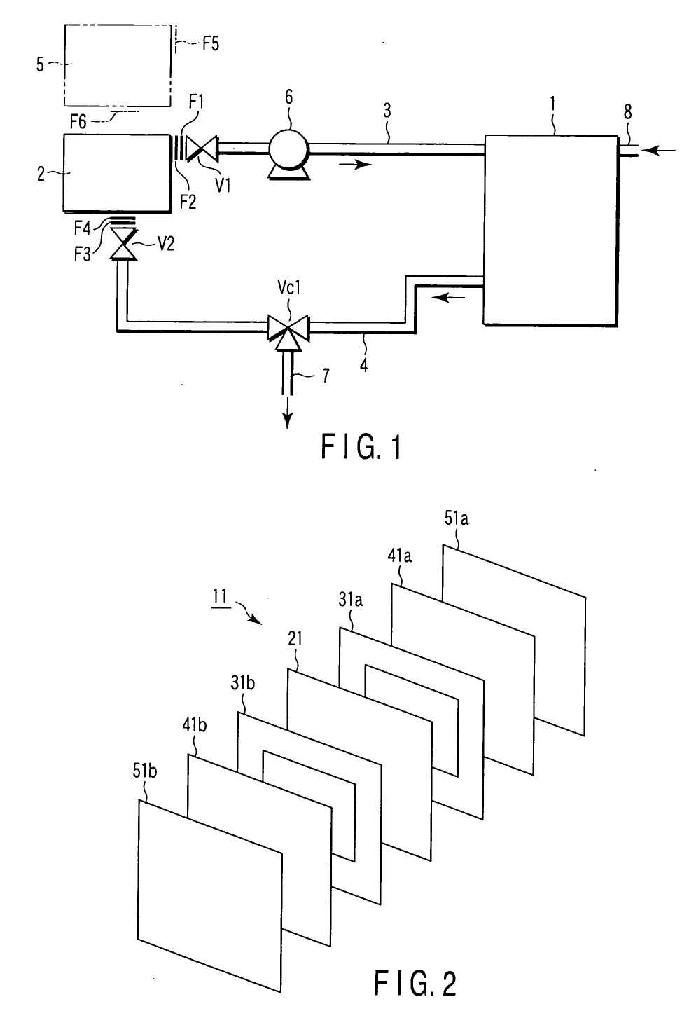

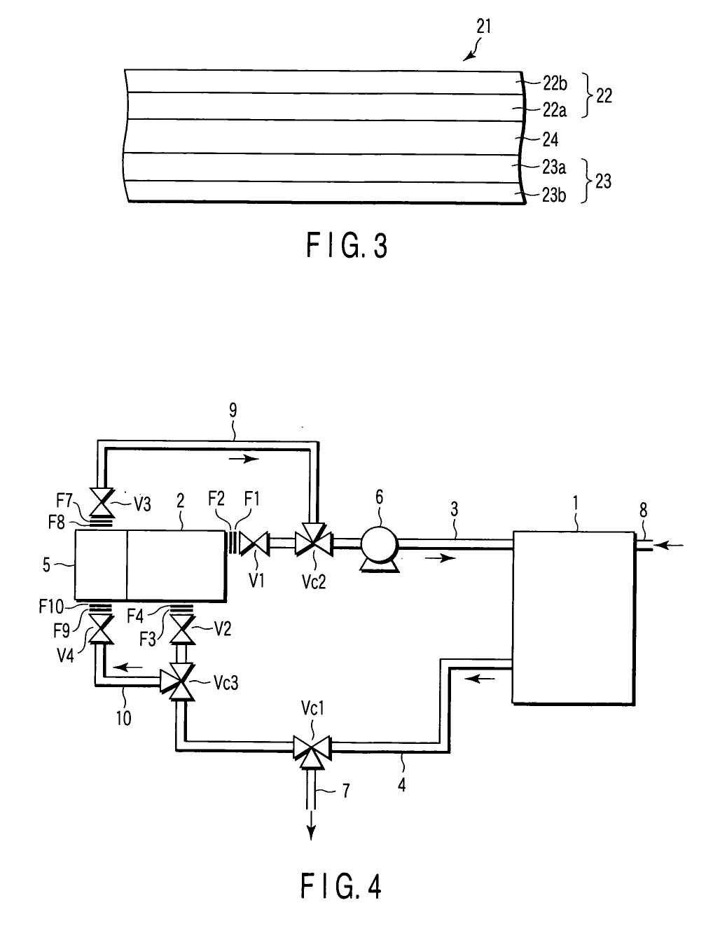

According to a first embodiment of the invention, FIG. 1 shows an exemplary schematic view of a direct methanol fuel cell; FIG. 2 shows an exemplary schematic exploded perspective view of a single cell assembled in a unit cell of FIG. 1; and FIG. 3 shows an exemplary sectional view of a membranes electrode unit assembled in the single cell of FIG. 2.

The reference numeral 1 in the drawing denotes a unit cell including 10 to 40 sheets of laminated single cells. A fuel tank 2 of, for example, a cartridge type in which a fuel including an aqueous methanol solution is filled is connected to the unit cell 1 through an outbound pipeline 3 and a homebound pipeline 4 as circulation pipelines so that the fuel recycles between the fuel tank 2 and unit cell 1.

A switching valve V1 is provided at an edge portion of the fuel tank 2 side in the outbound pipeline 3. The valve V1 and an outlet port of the fuel tank 2 are connectably and releasably joined via flanges F1 and F2. A switching valve V2 is provided at an edge portion of the homebound pipeline 4 at the fuel tank 2 side. The valve V2 and an inlet port of the fuel tank 2 are connectably and releasably joined via flanges F3 and F4. In other words, the fuel tank 2 is attachable to and detachable from the circulation pipelines (the outbound pipeline 3 and homebound pipeline 4). An outlet port and an inlet port of a cartridge of a cleaning liquid tank 5, which is filled with a cleaning liquid and shown by a virtual line, are connectably and releasably joined to the flange F1 of the outbound pipeline 3 via a flange F5, and to the flange F3 of the homebound pipeline 4 via a flange F6, respectively.

A fuel pump 6 is disposed on the outbound pipeline 3. A first three-way valve Vc1 as flow passageway switch means is disposed on the homebound pipeline 4. A drain pipe 7 for discharging the cleaning liquid is connected to the first three-way valve Vc1.

A feed pipe 8 for feeding an oxidizing gas, for example air, is connected to the unit cell 1.

A single cell 11 assembled into the unit cell 1 includes a membrane electrode unit 21 as shown in FIG. 2. A frame of a seal material 31a, a fuel flow passageway plate 41a, and a current collector plate 51a are aligned and laminated in this order on one face of the membrane electrode unit 21. A frame of a seal material 31b, a fuel flow passageway plate 41b, and a current collector plate 51b are aligned and laminated in this order on the other face of the membrane electrode unit 21.

As shown in FIG. 3, the membrane electrode unit 21 includes a fuel electrode 22 to which a fuel from the fuel tank 2 (or the cleaning liquid from the cleaning liquid tank 5) is supplied by recycling, an air electrode 23 to which oxidizing gas is supplied through the feed pipe 8, and an electrolyte membrane 24 interposed between the electrodes 22 and 23. The fuel electrode 22 is composed of a catalyst layer 22a in contact with the electrolyte membrane 24, and a diffusion layer 22b having a carbon paper laminated on the catalyst layer 22a. The air electrode 23 is composed of a catalyst layer 23a in contact with the electrolyte membrane 24 and a diffusion layer 23b having a carbon paper laminated on the catalyst layer 23a.

The aqueous methanol solution (a fuel) filled in the fuel tank 2 desirably has a methanol concentration of 0.1 to 99.5% by weight, more preferably 0.5 to 90% by weight, and most preferably 1 to 30% by weight.

The cleaning tank 5 is filled with a cleaning liquid containing a cyclic organic compound represented by the following general formula (I) as a cleaning agent:

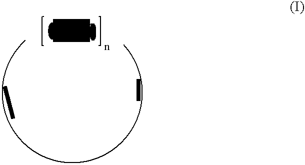

where R¹ denotes an alkyl chain with a carbon number of 1 to 12, R² denotes oxygen or sulfur, and n denotes an integer of 3 to 40.

R¹ in general formula (I) is preferably an alkyl chain with a carbon number of 1 to 8.

n in general formula (I) is preferably an integer of 2 to 20.

Examples of the cyclic organic compound represented by general formula (I) include 12-crown-4, 15-crown-5 and 18-crown-6.

The cleaning liquid preferably has a composition in which the cyclic organic compound is dissolved in a water soluble organic solvent and water.

The water soluble organic solvent is selected, for example, from methanol, ethanol, dimethylformamide and dimethylsulfoxide. Dimethylformamide is preferable among these water soluble organic solvents.

The concentration of the cyclic organic compound in the cleaning liquid is preferably 0.01 to 20% by weight. The trapping force for metal ions and organic substances adhered to the fuel electrode can be hardly enhanced when the concentration of the cyclic organic compound is less than 0.01% by weight. On the other hand, the viscosity of the cleaning liquid may be increased to cause a decrease of recycling ability while the cyclic organic compound may be precipitated, when the concentration of the cyclic organic compound exceeds 20% by weight. Accordingly, the concentration of the cyclic organic compound in the cleaning liquid is more preferably in the range of 0.3 to 5% by weight.

The concentration of the water soluble organic solvent in the cleaning liquid is preferably 0.5 to 30% by weight. It may be difficult to sufficiently dissolve the cyclic organic compound when the concentration of the water soluble organic solvent is less than 0.5% by weight. On the other hand, the pipe line may be dissolved at a concentration of the water soluble organic solvent of more than 30% by weight when the circulation pipeline is made of a synthetic resin. Accordingly, the concentration of the water soluble organic solvent in the cleaning liquid is more preferably in the range of 1.5 to 20% by weight.

The use of a scarcely water soluble organic solvent such as chloroform in place of the water soluble organic solvent is acceptable. When such organic solvent is used, the cleaning liquid forms an oil-in-water emulsion of an organic solvent in which the cyclic organic compound is dissolved.

The operation of the fuel cell system according to the first embodiment shown in FIGS. 1 to 3 will be described below.

The fuel tank 2 is integrated into the system by joining the flange F2 at the outlet port and the flange F4 at the inlet port of the fuel tank 2 to the flange F1 of the switching valve V1 of the outbound pipeline 3 and to the flange F3 of the switching valve V2 of the homebound pipeline 4, respectively. The valves V1 and V2 are opened, and the first three-way valve Vc1 is switched to the flow direction of the outbound pipeline 3. The fuel including the aqueous methanol solution in the fuel tank 2 is supplied to the fuel electrode 22 of the membrane electrode unit 21 of each single cell 11 constituting the unit cell 1 from the outlet port through the outbound pipeline 3 by operating the fuel pump 6. The unit cell 1 generates electricity by simultaneously supplying the oxidizing gas, for example air, to the air electrode 23 of the membrane electrode unit 21 of each single cell 11 from the feed pipe 8. The fuel supplied to the fuel electrode 22 of the membrane electrode unit 21 of each single cell 11 is discharged from the unit cell 1, and is recycled to the fuel tank 2 through the homebound pipeline 4 and inlet port.

After circulation of the fuel between the fuel tank 2 and unit cell 1, and after a desired amount of generation of electric power, the fuel tank 2 is replaced by the cleaning liquid tank 5. More specifically, the valves V1 and V2 are closed, and the flange F2 at the outlet port and the flange F4 at the inlet port of the fuel tank 2 are removed from the flange F1 of the valve V1 of the outbound pipeline 3 and the flange F3 of the valve V2 of the homebound pipeline 4, respectively, to disassemble the fuel tank 2 out of the system. Then, the cleaning liquid tank 5 is assembled into the system by joining the flange F5 at the outlet port and the flange F6 at the inlet port of the cleaning liquid tank 5 to the flange F1 of the valve V1 of the outbound pipeline 3 and the flange F3 of the valve V2 of the homebound pipe 4, respectively. Subsequently, the valves V1 and V2 are opened, and by operating the fuel pump 6, the cleaning liquid in the cleaning liquid tank 5 is supplied, from the outlet port through the outbound pipeline 3, to the fuel electrode 22 of the membrane electrode unit 21 of each single cell 11 constituting the unit cell 1 to clean the fuel electrode. The cleaning liquid after cleaning is recycled in order to allow the cleaning liquid to return to the cleaning liquid tank 5 through the homebound pipeline 4 and inlet port. By switching the first three-way valve Vc1 in the direction of flow of the drain pipe 7 after several cycles of circulation of the cleaning liquid, the cleaning liquid after the cleaning process is discharged from the system through the homebound pipeline 4, the first three-way valve Vc1 and the drain pipe 7.

After the cleaning, the cleaning tank 5 is replaced by the fuel tank 2 by the same procedure as described above, and the fuel is circulated again between the fuel tank 2 and unit cell 1 to resume generation of electricity.

When the fuel including the aqueous methanol solution in the fuel tank 2 is circulated between the unit cell 1 and the fuel tank through the outbound pipeline 3 and homebound pipeline 4 as circulation pipelines in the circulating fuel cell system according to the first embodiment, impurities generated in the unit cell 1, outbound pipeline 3, homebound pipeline 4 and fuel pump 6 (for example metal ions such as Al ions and organic substances) are accumulated on the fuel electrode 22 of the membrane electrode unit 21 of each single cell 11 constituting the unit cell 1 with time. For solving the problem of accumulation of impurities, the fuel tank 2 is replaced with the cleaning liquid tank 5; the cleaning liquid in the cleaning liquid tank 5 is supplied, through the outbound pipeline 3, to the fuel electrode 22 of the membrane electrode unit 21 of each single cell 11 constituting the unit cell 1; the cleaning liquid is recycled to the cleaning liquid tank 5 through the homebound pipeline 4; and the cleaning liquid after cleaning is finally discharged from the system through the homebound pipeline 4, the first three-way valve Vc1 and drain pipe 7. At this time, since the cyclic organic compound represented by general formula (I) has a high capture ability against the metal ions such as Al ions and organic substances, the metal ions such as Al ions and organic substances accumulated in the circulation pipelines as well as on the fuel electrode may be efficiently captured and removed. Consequently, a decrease of activity resulting from accumulation on the catalyst layer 22a of the fuel electrode 22 of the membrane electrode unit 21 during a desired time period of circulation of the fuel may be resumed. Therefore, a high-performance fuel cell system capable of maintaining high output power for a long period may be realized.

Capture ability for the metal ions such as Al ion and organic substances may be further improved by enhancing solubility of the cyclic organic compound by concomitantly using an organic solvent as the cleaning liquid.

According to second embodiment of the invention, FIG. 4 shows an exemplary schematic view of a direct methanol fuel cell. The same members as those described in FIG. 1 are given the same reference numerals in FIG. 4, and descriptions thereof are omitted.

The fuel cell system includes a fuel tank 2 and cleaning liquid tank 5 which are integrated as a cartridge. A second three-way valve Vc2 is disposed on an outbound pipeline 3 at the upstream side of a fuel pump 6. A third three-way valve Vc3 is disposed on a homebound pipeline 4 at the downstream side of the first three-way valve Vc1. The cleaning liquid tank 5 is connected to the second three-way valve Vc2 through an outbound bypass pipeline 9. A switching valve V3 is provided at the end of the outbound bypass pipeline 9 at the cleaning liquid tank 5 side, and the valve V3 and an outlet port of the cleaning liquid tank 5 are connectably and releasably joined via flanges F7 and F8. The cleaning liquid tank 5 is connected to the third three-way valve Vc3 through a homebound bypass pipeline 10. A switching valve V4 is provided at the end of the homebound bypass pipeline 10 at the cleaning liquid tank 5 side, and the valve V4 and an inlet port of the cleaning liquid tank 5 are connectably and releasably joined via flanges F9 and F10.

In the fuel cell system above, the fuel tank 2 is connectably and releasably joined to the outbound pipeline 3 and homebound pipeline 4 via flanges F1 and F2, and flanges F3 and F4, respectively. The outlet port of the cleaning liquid tank 5 is connectably and releasably joined to the switching valve V3 of the outbound bypass pipeline 9 via the flanges F7 and F8, and the inlet port of the cleaning liquid tank 5 is connectably and releasably joined to the switching valve V4 of the homebound bypass pipeline 10 via the flanges F9 and F10. Both the fuel tank 2 and cleaning liquid tank 5 are arranged to be attachable and detachable relative to the circulation pipelines (outbound pipeline 3 and homebound pipeline 4) by the connection mode as described above.

The operation of the fuel cell system according to the second embodiment shown in FIG. 4 will be described below.

The switching valves V1 and V2 are opened; the second three-way valve Vc2 is switched in the direction of flow of the outbound pipeline 3; and the first and third three-way valves Vc1 and Vc3 are switched in the direction of flow of the homebound pipeline 4. The fuel including an aqueous methanol solution in the fuel tank 2 is supplied to a fuel electrode 22 of a membrane electrode unit 21 of each single cell 11 constituting a unit cell 1 through the outbound pipeline 3 from the outlet port by operating the fuel pump 6. An oxidizing gas, for example air, is concomitantly supplied from a feed pipe 8 to an air electrode 23 of the membrane electrode unit 21 of each single cell 11 to generate electricity in the unit cell 1. The fuel supplied to the fuel electrode 22 of the membrane electrode unit 21 of each single cell 11 is discharged from the unit cell 1, and is returned to the fuel tank 2 through the homebound pipeline 4 and inlet port to recycle the fuel.

The fuel flow is switched to the cleaning liquid tank 5 side after circulation between the fuel tank 2 and unit cell 1 and generation of electricity for a desired period of time. More specifically, the switching valves V1 and V2 are closed, and the second three-way valve Vc2 is switched so that the outbound bypass pipeline 9 is in communication with the outbound pipeline 3 at the fuel pump 6 side. In addition, the third three-way valve Vc3 is switched so that the homebound pipeline 4 at the first three-way valve Vc1 side is in communication with the homebound bypass pipeline 10. The switching valve V3 of the outbound bypass pipeline 9 and the switching valve V4 of the homebound bypass pipeline 10 are made open thereafter. Subsequently, by operating the fuel pump 6, the cleaning liquid in the cleaning liquid tank 5 is supplied to the fuel electrode 22 of the membrane electrode unit 21 of each single cell 11 constituting the unit cell 1 from the outlet port through the outbound bypass pipeline 9, the second three-way valve Vc2 and the outbound pipeline 3 to clean the fuel electrode. The cleaning liquid after the cleaning returns to the cleaning liquid tank 5 through the homebound pipeline 4, the third three-way valve Vc3, the homebound bypass pipeline 10 and the inlet port. That is, the cleaning liquid is recycled. By switching the first three-way valve Vc1 in the direction of flow of the drain pipe 7 after several times of recycling of the cleaning liquid, the cleaning liquid after the cleaning is discharged out of the system through the homebound pipeline 4, the first three-way valve Vc1 and the drain pipe 7.

After the cleaning, the fuel cell 2 is switched again so that it is connected to the circulation pipelines (the outbound pipeline 3 and homebound pipeline 4) by the same procedure as described above in order to allow the fuel to be circulated between the fuel tank 2 and the unit cell 1 a for generation of electricity.

When the fuel liquid of the fuel tank 2 is replaced with a fresh fuel or when the cleaning liquid in the cleaning liquid tank 5 has been used up, the valves V1 and V2 are closed, and the flange F2 at the outlet port of the fuel tank 2 and the flange F4 at the inlet port are displaced from the flange F1 of the valve V1 of the outbound pipeline 3 and flange F3 of the valve V2 of the homebound pipeline 4, respectively. Then, the valves V3 and V4 of the outbound bypass pipeline 9 and the homebound bypass pipeline 10 are closed, respectively, and the flange F8 at the outlet port and the flange F10 at the inlet port of the cleaning liquid tank 5 are displaced from the flange F7 of the valve V3 of the outbound bypass pipeline 9 and flange F9 of the valve V4 of the homebound bypass pipeline 10, respectively. This procedure allows the integrated fuel tank 2 and cleaning liquid tank 5 to be removed out of the system to allow the fuel tank 2 to be filled with a fresh fuel and the cleaning liquid tank 5 to be replenished with the cleaning liquid.

When the fuel including the aqueous methanol solution in the fuel tank 2 is circulated between the fuel tank 2 and unit cell 1 through the outbound pipeline 3 and the homebound pipeline 4 as the circulation pipelines in the circulating fuel cell system according to the second embodiment, impurities (for example, metal ions such as Al ions and organic substances) generated in the unit cell 1, the outbound pipeline 3, the homebound pipeline 4 and the fuel pump 6 are accumulated on the fuel electrode 22 of the membrane electrode unit 21 of each single cell 11 constituting the unit cell 1 with time. For solving the problem of accumulation of the impurities, connection of the pipelines is switched from the fuel tank 2 side to the cleaning liquid tank 5 side; the cleaning liquid in the cleaning liquid tank 5 is supplied to the fuel electrode 22 of the membrane electrode unit 21 of each single cell 11 constituting the unit cell 1 through the outbound bypass pipeline 9 and the homebound pipeline 3; the cleaning liquid is allowed to return to the cleaning liquid tank 5 through the homebound pipeline 4 and the homebound bypass pipeline 10; and finally the cleaning liquid after cleaning is discharged from the system through the homebound pipeline 4, the third three-way valve Vc3 and the drain pipe 7. At this time, since the cyclic organic compound represented by general formula (I) dissolved in the cleaning liquid has a high capture ability against the metal ions such as Al ions and organic substances, the metal ions such as Al ions and organic substances accumulated in the circulating pipelines as well as on the fuel electrode may be efficiently captured and removed. Consequently, a decrease of activity resulting from accumulation of impurities on the catalyst layer 22a of the fuel electrode 22 of the membrane electrode unit 21 during circulation of the fuel for a desired period may be resumed. Therefore, a high-performance fuel cell system capable of maintaining high output power for a long period may be realized.

In particular, capture ability for the metal ions such as Al ions and organic substances may be further improved by enhancing solubility of the cyclic organic compound represented by general formula (I) by concomitantly using an organic solvent as the cleaning liquid.

Examples of the invention will be described in detail hereinafter.

### PREPARATION EXAMPLE 1 OF THE CLEANING LIQUID

Cleaning liquid A (300 mL) was prepared by dissolving 0.5% by weight of 12-crown-4 represented by structural formula (A) below and 10% by weight of N,N-dimethylformamide in water.

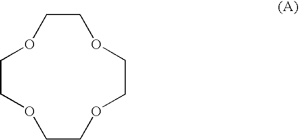

### PREPARATION EXAMPLE 2 OF THE CLEANING LIQUID

Cleaning liquid B (300 mL) was prepared by dissolving 0.5% by weight of 15-crown-5 represented by structural formula (B) below and 10% by weight of N,N-dimethylformamide in water.

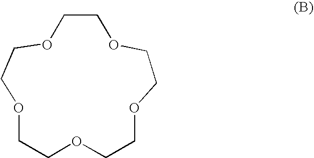

### PREPARATION EXAMPLE 3 OF THE CLEANING LIQUID

Cleaning liquid C (300 mL) was prepared by dissolving 0.5% by weight of 18-crown-6 represented by structural formula (C) below and 10% by weight of N,N-dimethylformamide in water.

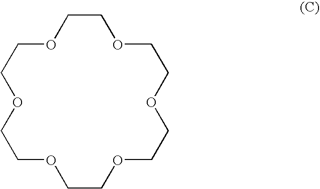

(Assemble of Fuel Cell Stack)

An anode (a fuel electrode) was formed by thermal compression bonding of a platinum-ruthenium catalyst layer and a diffusion layer containing carbon powder-carbon paper on one surface of a perfluoroalkylsulfone membrane (trade name Nafion 112 membrane, manufactured by DuPont Co.) in this order. A cathode (an air electrode) was formed by thermal compression bonding of a platinum catalyst layer and a diffusion layer containing carbon powder-carbon paper on the other surface of the perfluoroalkylsulfone membrane in this order to prepare a membrane electrode unit with an electrode surface area of 5 cm². Subsequently, a carbon separator having columnar flow passageways and a current collector were laminated on both surfaces of the membrane electrode unit, respectively, in this order, and a single cell (a fuel cell stack) was assembled by fastening the membranes with bolts.

(Construction of Simple Fuel Cell System)

A rectangular flat fuel cartridge made of an ABS resin with a length of 150 mm, a width of 40 mm and a height of 20 mm was connected to the fuel electrode of the above-mentioned fuel cell stack with an outbound silicon tube with an inner diameter of 4 mm, and the fuel electrode was connected to the fuel cartridge with a homebound silicon tube with an inner diameter of 4 mm. A fuel pump was disposed on the outbound silicon tube. A three-way cock was disposed on the homebound silicon tube, and a drain silicon tube was connected to a third valve of the cock. The fuel cartridge was replaceable with a rectangular flat cleaning liquid cartridge made of an ABS resin with a length of 150 mm, a width of 40 mm and a height of 20 mm. The fuel pump was attached to an air electrode of the fuel cell stack. A stack terminal of a current-voltage meter was connected to an electron load apparatus of the fuel cell stack. A simple fuel cell system was constructed by assembling these components.

### EXAMPLE 1

1. Quantitative Assay of Metal Ion Concentration

Fuel (100 mL) including a 6% aqueous methanol solution was filled in the fuel cartridge of the simple fuel cell system, and the fuel was supplied to the fuel electrode of the fuel cell stack through the outbound silicon tube at a flow rate of 8 mL/min by operating the fuel pump. The fuel was circulated to return it to the fuel cartridge through the homebound silicon tube. Air was concomitantly supplied to the air electrode of the fuel cell stack at a flow rate of 10 mL/min by operating an air pump to generate electricity at the fuel cell stack.

Generation of electricity by the fuel cell stack was continued for 100 hours by circulation of the fuel and supply of air. The fuel cartridge was replaced with the cleaning liquid cartridge in which 100 mL of the cleaning liquid (A) was filled, and the cleaning liquid was supplied to the fuel electrode of the fuel cell stack at a flow rate of 8 mL/min through the outbound silicon tube by operating the fuel pump. The fuel was returned to the fuel cartridge by recycling it for 3 hours through the homebound silicon tube. Subsequently, the three-way cock was turned to the drain silicon tube side to discharge the cleaning liquid in the circulating silicon tube out of the system. Then, the three-way cock was returned to its original position, and the cleaning liquid cartridge was replaced with a cartridge filled with 100 mL of pure water, which was allowed to circulate through the same passageway as flowing the cleaning liquid for 5 minutes by operating the fuel pump. The three-way cock was turned to the drain silicon tube side thereafter, and 50 ml of circulating water was drained through the drain silicon tube into a vial container.

The concentrations of aluminum, calcium and sodium ions of metal ions dissolved in water were quantified using oxidative decomposition—ICP-MAS (trade name SPQ-9000, manufactured by Seiko Electronic Co.).

2. Quantitative Assay of Organic Substances

When the simple fuel cell system was continuously operated for 8 hours per day by circulating the fuel, the fuel cartridge was replaced with the cleaning liquid cartridge for every 100 hours' operation, and the cleaning liquid (A) was circulated for 5 minutes. Subsequently, the three-way cock was turned to the drain tube side, and the cleaning liquid in the circulating silicon tube was discharged out of the system. Then, the three-way cock was returned to its original position, and the cleaning liquid cartridge was replaced with a cartridge filled with 100 mL of pure water, which was allowed to circulate for 5 minus through the same passageway as that of the cleaning liquid by operating the fuel pump. The three-way cock was turned to the drain silicon tube side, and 80 mL of circulating water was allowed to drain through the drain silicon tube into a vial container.

Organic substances in pure water obtained were quantified by a high-speed liquid chromatograph (trade name PU-2089, manufactured by JASCO).

3. Measurement of Current-voltage Characteristics

As described in item 1 above, the three-way cock was returned to its original position after circulating the cleaning liquid (A) for 3 hours, and the cleaning liquid cartridge was replaced with a new fuel cartridge. Supply of the fuel to the fuel electrode, circulation and supply of air to the air electrode of the fuel cell stack with the air pump was repeated thereafter under the same condition as described above to generate electricity with the fuel cell stack. At this time, the current-voltage characteristics were observed with a current-voltage meter.

### EXAMPLE 2

Items 1 to 3 above were evaluated by the same method as in Example 1, except that the cleaning liquid cartridge filled with the cleaning liquid (B) was used for cleaning the fuel cell stack.

### EXAMPLE 3

Items 1 to 3 above were evaluated by the same method as in Example 1, except that the cleaning liquid cartridge filled with the cleaning liquid (C) was used for cleaning the fuel cell stack.

### COMPARATIVE EXAMPLE 1

Item 3 above was evaluated by the same method as in Example 1, except that a cleaning liquid cartridge filed with a cleaning liquid, which was prepared by dissolving 0.5% by weight of ethylenediamine tetraacetic acid (EDTA) as a chelating agent in water, was used for cleaning the fuel cell stack.

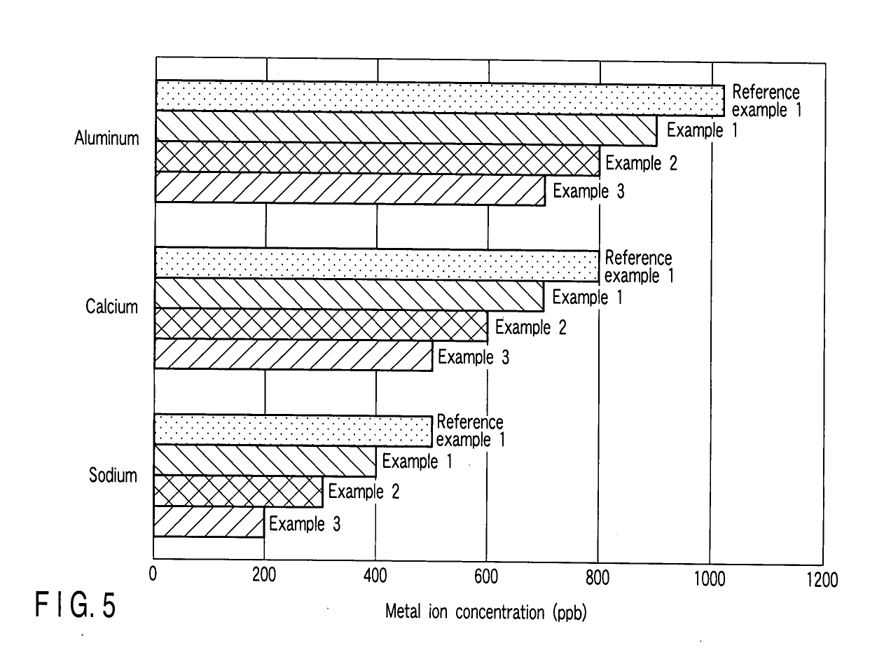

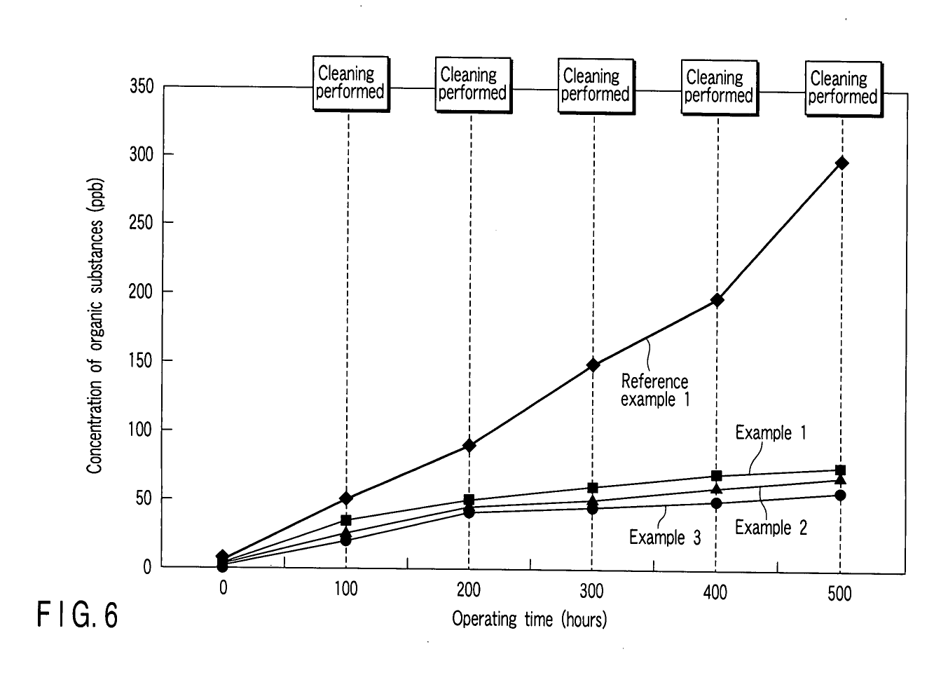

The results of evaluation with respect to items 1 and 2 in Examples 1 to 3 are shown in FIGS. 5 and 6, respectively. Reference Example 1 in FIG. 5 shows the result of the quantitative assay of the concentration of each metal ion in circulating water without cleaning with the cleaning liquid after 3 hours of circulation of the fuel (power generation) in the evaluation of item 1. Reference Example 2 in FIG. 6 shows the result of the quantitative assay of the concentration of organic substances in circulating water at every 100 hours of operation for evaluating with respect to item 2 without cleaning with the cleaning liquid at every 100 hours of operation, when the fuel cell stack was continuously operated under the operation condition of 8 hours per day.

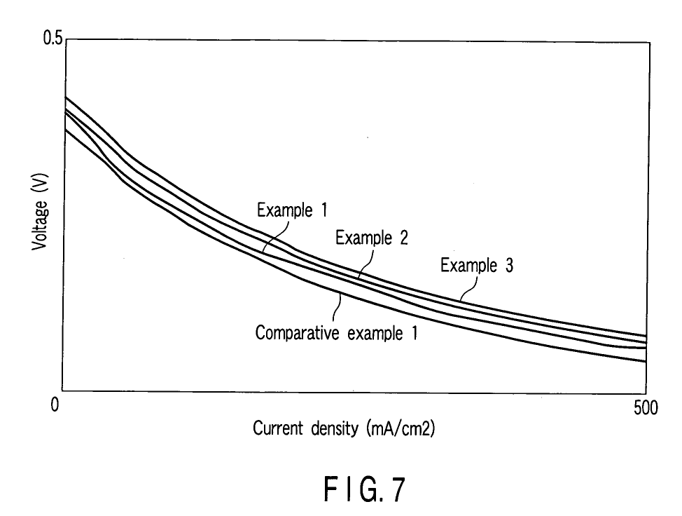

The results of evaluation with respect to item 3 in Comparative Example 1 are shown in FIG. 7.

FIG. 5 clearly shows that the metal ion concentrations are suppressed by as much as 20% or more in the circulation system including the fuel electrode, in Example 1 using the cleaning liquid (A) containing 12-crown-4, in Example 2 using the cleaning liquid (B) containing 15-crown-5 and in Example 3 using the cleaning liquid (C) containing 18-crown-6, as compared with the result in Reference Example 1 in which no cleaning with the cleaning liquid is applied.

FIG. 6 clearly shows that the organic substance concentrations are suppressed to be ⅕ or less in the circulation system including the fuel electrode, in Example 1 using the cleaning liquid (A) containing 12-crown-4, in Example 2 using the cleaning liquid (B) containing 15-crown-5 and in Example 3 using the cleaning liquid (C) containing 18-crown-6, as compared with the result in Reference Example 1 in which no cleaning with the cleaning liquid is applied.

FIG. 7 clearly shows that the output power of the fuel cell stack is increased after cleaning, in Example 1 using the cleaning liquid (A) containing 12-crown-4, in Example 2 using the cleaning liquid (B) containing 15-crown-5 and in Example 3 using the cleaning liquid (C) containing 18-crown-6, as compared with the result in Comparative Example 1 in which the cleaning liquid containing ethylenediamine tetraacetic acid was used.

While certain embodiments of the inventions have been described, these embodiments have been presented by way of example only, and are not intended to limit the scope of the inventions. Indeed, the novel methods and systems, described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell system comprising:
a cell unit having a plurality of laminated single cells;
a circulating pipeline connected to a fuel electrode of each single cell of the cell unit;
a cartridge fuel tank attachably and detachably disposed on the circulating pipeline and filled with a fuel comprising an aqueous methanol solution;
a cleaning liquid tank attachably and detachably disposed on the circulating pipeline and filled with a cleaning liquid containing a cyclic organic compound represented by a general formula (I) below as a detergent;
a fuel pump disposed on the circulating pipeline; and
flow passageway switching means for discharging the cleaning liquid after cleaning the fuel electrode of the cell unit, the switching means being disposed on a downstream side of the cell unit. 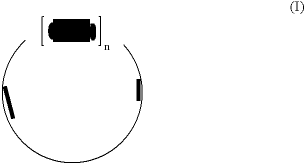
where R¹ denotes an alkyl chain with a carbon number of 1 to 12, R² denotes oxygen or sulfur, and n denotes an integer of 3 to 40.

2. The fuel cell system according to claim 1, wherein the fuel tank and the cleaning liquid tank are alternately and detachably disposed on the circulating pipeline.

3. The fuel cell system according to claim 1, wherein the fuel tank is integrated with the cleaning liquid tank and the cleaning liquid tank is connected to the circulating pipeline through a bypass pipeline having a switching valve.

4. The fuel cell system according to claim 1, wherein R¹ in the general formula (I) is an alkyl chain with a carbon number of 1 to 8.

5. The fuel cell system according to claim 1, wherein n in the general formula (I) is an integer of 2 to 20.

6. The fuel cell system according to claim 1, wherein the cyclic organic compound represented by the general formula (I) is 12-crown-4, 15-crown-5 or 18-crown-6.

7. The fuel cell system according to claim 1, wherein the cleaning liquid has a composition in which the cyclic organic compound is dissolved in a water soluble organic solvent and water.

8. The fuel cell system according to claim 7, wherein the cleaning liquid has the concentration of the cyclic organic compound of 0.01 to 20% by weight.

9. The fuel cell system according to claim 7, wherein the cleaning liquid has the concentration of the water soluble organic solvent of 0.5 to 30% by weight.

10. The fuel cell system according to any one of claims 7 to 9, wherein the water soluble organic solvent is selected from methanol, ethanol, dimethylformamide and dimethylsulfoxide.
